(19) United States
(12) Patent Application Publication
(10) Pub. No.: US 2009/0063637 A1
(43) Pub. Date: Mar. 5, 2009

(54) SYSTEM AND METHOD FOR PROVIDING MESSAGE STATUS IN CHAT MESSAGING

(75) Inventors: Lin Sun, Morrisville, NC (US); Thomas Richard Haynes, Apex, NC (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/845,453

(22) Filed: Aug. 27, 2007

(51) Int. Cl. G06F 15/16

(52) U.S. Cl. 709/206

(57) ABSTRACT

A method for indicating in a messaging client the status of a sent message. The method can include the steps of composing a message in a messaging client associated with a sender, sending said message to at least one recipient, receiving a status message from a messaging client associated with said at least one recipient, wherein said status message indicates a likelihood that said at least one recipient has read said message, and in response to receiving said status message, altering an indicia in said sender messaging client to indicate said likelihood that said sent message has been read by said at least one recipient.

### FIELD OF THE INVENTION

The present invention relates generally to the field of chat messaging systems. More particularly, the present invention relates to methods and systems for providing chat message status in chat messaging clients.

### BACKGROUND OF THE INVENTION

Generally, during instant messaging or chat messaging communications, the sender cannot be absolutely sure that a message was delivered to the recipient, as delivery of chat messages cannot be always guaranteed and there is generally no successful delivery indication/confirmation available in most chat and instant messaging client software. This situation can be more problematic when the sender or recipient is communicating using a wireless connection at a remote location. The typical workaround for such problems is for the sender to send a follow up message (for example—“Did you get my message?”) in order to confirm with the recipient that he/she has received the previous message. However, sending follow-up messages requires the sender to spend additional time composing a second message. Furthermore, receipt of such confirmation messages can be disruptive to the recipient and frustrating or annoying, especially when the original message has been received successfully by the recipient. Therefore, what is needed is a system and method for providing chat message status to a sender.

### SUMMARY OF THE INVENTION

In a first embodiment of the invention, a method for indicating in a messaging client the status of a sent message is provided. The method can include the steps of composing a message in a messaging client associated with a sender, sending the message to at least one recipient, receiving a status message from a messaging client associated with at least one recipient, where the status message indicates a likelihood that at least one recipient has read the sent message, and in response to receiving the status message, altering an indicia in the sender messaging client to indicate the likelihood that the sent message has been read by at least one recipient.

In a second embodiment of the invention, a system for supporting messaging between a plurality of users is provided. The system can include a messaging server for sending to at least one recipient a message composed in a messaging client associated with a sender and for forwarding a status message from a messaging client associated with at least one recipient to the sender messaging client, where the status message indicates a likelihood that at least one recipient has read the message, and where the sender messaging client alters an indicia in the sender messaging client so as to indicate the likelihood that the message has been read by at least one recipient in response to receiving the status message.

In a third embodiment of the invention, a computer-readable storage medium is provided, having stored thereon a computer program having a plurality of code sections comprising computer instructions executable by a computer. The storage medium can include computer instructions for sending a message composed in a sender messaging client to at least one recipient messaging client, for receiving a status message from the at least one recipient messaging client, where the status message indicates a likelihood that a recipient associated with the at least one recipient messaging client has read the message, and for altering an indicia in the sender messaging client in response to receiving the status message to indicate the likelihood that the message has been read by a recipient associated with the at least one recipient messaging client.

This Summary is provided to comply with 37 C.F.R. §1.73, requiring a summary of the invention briefly indicating the nature and substance of the invention. It is submitted with the understanding that it will not be used to interpret or limit the scope or meaning of the claims.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a communications network in which some embodiments of the present invention are used and practiced.

FIG. 2A is a schematic view of a client-server messaging architecture for use with some embodiments of the present invention.

FIG. 2B is a schematic view of a peer-to-peer messaging architecture for use with some embodiments of the present invention.

FIG. 3A is an exemplary chat client interface in accordance with embodiments of the present invention.

FIG. 3B is the exemplary chat client interface of FIG. 3A indicating successful delivery of a message in accordance with embodiments of the present invention.

FIG. 3C is the exemplary chat client interface of FIG. 3A indicating a low likelihood that a message has been read by a recipient in accordance with embodiments of the present invention.

FIG. 3D is the exemplary chat client interface of FIG. 3A indicating a high likelihood that a message has been read by a recipient in accordance with embodiments of the present invention.

FIG. 4A is a view of an exemplary chat client interface for sending messages to multiple recipients indicating a low likelihood that a message has been read by the multiple recipients in accordance with embodiments of the present invention.

FIG. 4B is a view of the exemplary chat client interface of FIG. 4A for sending messages to multiple recipients indicating a high likelihood that a message has been read by the multiple recipients in accordance with embodiments of the present invention.

FIG. 4C is an alternate view of the exemplary chat client interface of FIG. 4A for sending messages to multiple recipients indicating a high likelihood that a message has been read by one or more of multiple recipients in accordance with embodiments of the present invention.

FIG. 4D is another alternate view of the exemplary chat client interface of FIG. 4A for sending messages to multiple recipients indicating a high likelihood that a message has been read by one or more of multiple recipients in accordance with embodiments of the present invention.

FIG. 5 is a flowchart of exemplary steps of a method according to an embodiment of the present invention.

FIG. 6 is a schematic view of a computer system within which a set of instructions operate according to an embodiment of the invention.

### DETAILED DESCRIPTION

The present invention is described with reference to the attached figures, wherein like reference numerals are used throughout the figures to designate similar or equivalent elements. The figures are not drawn to scale and are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant arts, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

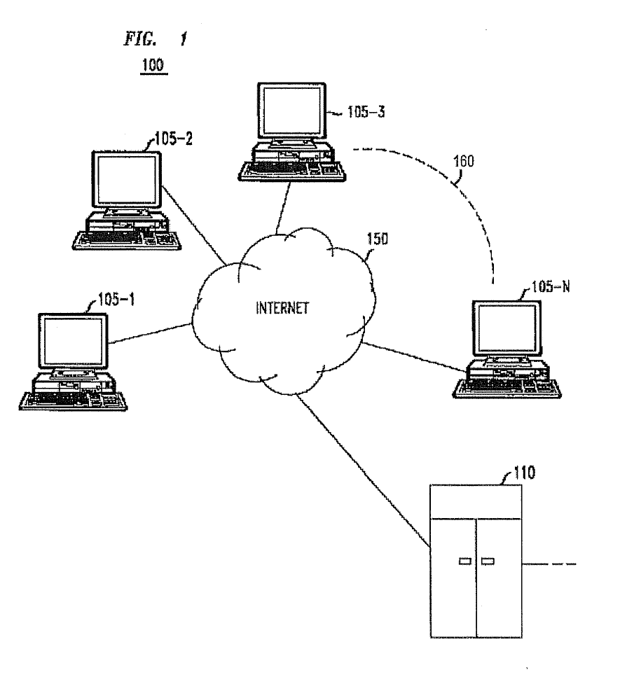

FIG. 1 shows an illustrative data communications system 100. System 100 can be an on-line service network, or any other message-handling network. In system 100 a representative plurality of personal computers, workstations, or terminals (collectively “terminals”), 105-i, i=1, 2, . . . , N, are shown connected by way of wireline or wireless access paths through a data network (illustratively, the Internet) 150 to a server 110. N can be any positive integer, subject to transmission and processor capacity limitations.

Server 110 is shown with dashed lines on its right to indicate that the server functions may be distributed over an arbitrary number of networked cooperating servers. Each terminal 105-i is connected (through standard access facilities) to an associated server. In some cases all terminals will be associated with the same server, but one or more terminals can be connected to each of a group of servers. In typical operation, the terminals 105-i can execute client software for cooperating with server software running on a respective server 110 to enable chat and/or instant messaging functionalities. In some embodiments, two or more terminals 105-i can be additionally or alternatively coupled directly to each other, as shown by communications link 160 in FIG. 1.

It is within the scope of the invention for a terminal 105-i to represent any multimode communication device including, but not limited to, a cell phone, a personal computer or laptop, or personal digital assistant capable of supporting wireline and/or wireless communication technologies. In the case of wireline communications, a terminal 105-i can utilize xDSL, cable, or PSTN telephony interfaces for communicating over data network 150 which can include hybrid technologies that support circuit-switched packet-switched communications. The terminal 105-i can also support accessory interfaces such as USB, Firewire, and other connectivity technologies.

Alternatively, or in combination, the terminal 105-i supports any number of wireless communication protocols such as the family of 802.xx protocols defined by the Institute of Electrical and Electronics Engineers (IEEE). For instance, terminal 105-i can utilize long-range wireless access technologies such as, for example, cellular, software defined radio (SDR) and/or WiMAX to communicate with network 150. Cellular access technologies can include, for example, CDMA-1X, UMTS/HSDPA, GSM/GPRS, TDMA/EDGE, EV/DO, and next generation technologies as they arise. Additionally, a terminal 105-i can support short-range wireless technologies such as WiFi, Bluetooth, Zigbee, or cordless communications such as digital enhanced cordless telecommunications (DECT).

In the present invention, standard chat messaging and instant messaging methodologies, well known to those of ordinary skill in the art, are modified and extended in accordance with aspects of the present invention so as to realize the inventive functionalities. Features and operations of illustrative systems, methods and protocols for achieving advantages of the present invention are described with particularity below.

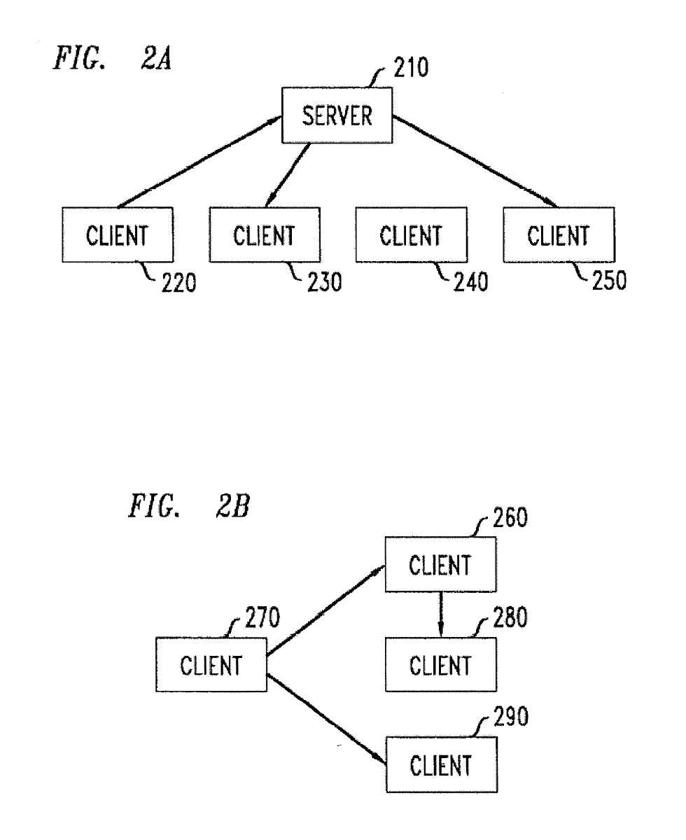

A principal mechanism for communicating messages and managing windows for managing and viewing chat conversations in accordance with illustrative embodiments of the present invention can include the well-known client-server architecture. FIG. 2A illustrates a simple client-server architecture for message handling in accordance with embodiments of the present invention. In FIG. 2A, a snapshot of activity among a sampling of network elements, messages are seen to be sent from one client (illustratively client 220) to a server 210. At server 210, processing of the message can be performed to effect control and distribution of messages in a conversation (to clients 230 and 250, for example). At other times, clients such as 230, 240 or 250 can originate messages that are processed by server 210 and can forward the messages, as appropriate, to other clients. In accordance with aspects of the invention, a client can maintain a plurality of simultaneous plural-participant conversations.

Alternatively, many of the message handling and window control operations used in embodiments of the present invention can be accomplished using a peer-to-peer interconnection among clients. Such a system arrangement is shown in a simplified example in FIG. 2B, where clients 260, 270, 280 and 290 are shown selectively communicating messages. Because a message format can be used, a receiving client can identify the chat conversation with which a message is associated and much of the routing and window control functionality can be left to the client software at user terminals. As with the client-server architecture, a client can maintain plural simultaneous conversations, each with a plurality of other participants.

Regardless of whether the messaging system operates using a client-server architecture or a peer-to-peer architecture, the present invention provides a system and method for generating, transmitting, and receiving chat messages and client status messages over data network 150, where the client status messages are indicative of a likelihood that the recipient has read the message as well. In the various embodiments, indicia can be provided in a sender's chat client that a message has been received or that a message has likely been read. Thus, the present invention provides for determining if the likelihood that a message has been read based on the state of the recipient's chat client or terminal. By providing an indication that the message has likely been read, the sender does not need to confirm messages and the recipient does not need to take any action to inform the sender that a message has been read or likely read and will likely not be disturbed by further messages from the sender.

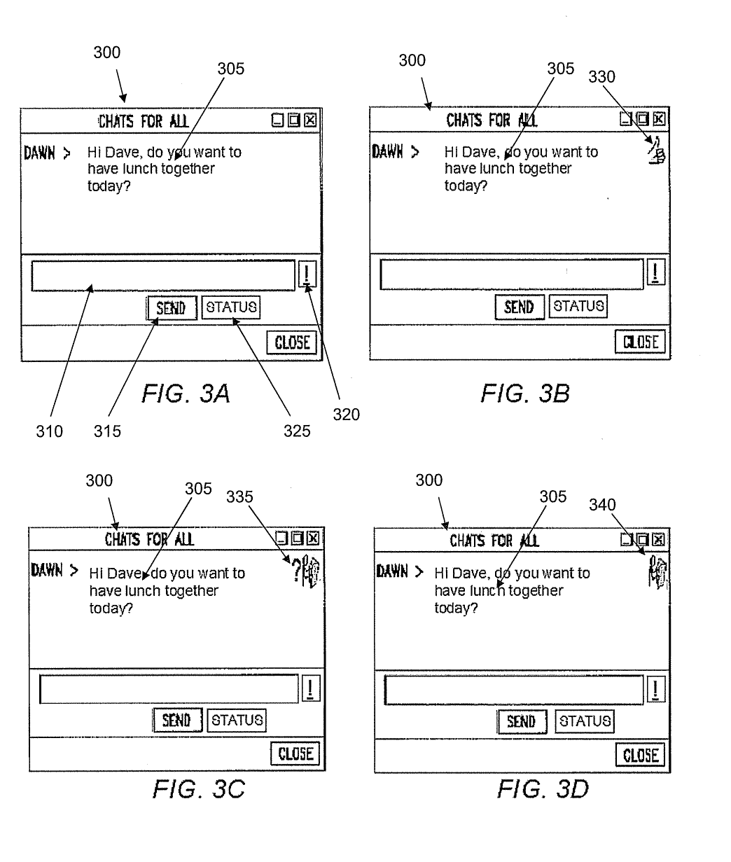

A graphical user interface (GUI) 300 for a chat client for use with an embodiment of the present invention is shown in FIG. 3A. The GUI 300 can include a display region 305, which shows all messages sent by the various senders during a chat messaging session. Typically, each message is set off by the sender's name or identification (“DAWN”) and followed by the text of the message (“Hi Dave, . . . ”). The GUI 300 can also include an input region 310 for entering the message and a send control 315 to instruct the client to deliver the message.

However, the present invention can provide additional functionality in the GUI 300. For example, a sender can select whether or not a status of the message is to be delivered to the sender's chat client after the message is delivered. One method of providing such functionality is a priority selection control 320. In FIG. 3A, the priority control 320 is shown as a “!” button next to the input region 310. Thus, after entering the message, the sender can select with the priority control 320 whether a status for the particular message should be reported back to the sender's chat client after delivery. However, those of ordinary skill in the art will recognize that the present invention is not limited to a button for the selection control 320 and other GUI input objects can be used, including, but not limited to, drop down menus, selection boxes, or other objects. Additionally or alternatively, the message typed into the input region 310 can include a textual code which can be recognized by the recipient chat client and can cause the recipient chat client to generate a status message. Although the chat client in such embodiments can check the status when the chat message is received, the chat client can also be configured to continuously check its status and forward a status message anytime it determines that a message has likely been read.

Furthermore, the present invention is not limited to only being able to request a status of message only when the message is sent. In some embodiments, a status control can be provided to check the status of a message at any time. In such embodiments, a message already sent by the sender can be selected from the display region and the status control can be activated to query the system on the status of the message. For example, in FIG. 3A a status button 325 is provided to check status of messages. In another embodiment, merely selecting the message can prompt the sender's chat client to signal the recipient's chat client to determine if a message has likely been read. Various methodologies for selecting a message in the display region or area 305 are well known to those of ordinary skill in the art and are within the scope of the present invention.

The GUI 300 can be configured to provide various indicia to the sender that the message has been received. For example, as shown in FIG. 3B, a delivery successful icon 330 can be displayed in the GUI 300 alongside a message in the display area 305 once it is determined by the chat system that the recipient's chat client has successfully received the message. Various types of icons can be used to represent a successful delivery. However, the invention is not limited in this regard, and the GUI 300 can instead be modified by adjusting a color, font, or size of the message displayed in the display area 305 when the message has been successfully delivered to the recipient's chat client. Additionally, a combination of altered indicia can also be used

The GUI 300 can also be configured to provide various indicia to the sender that the message, even though received, has likely not been read by the recipient. For example, as shown in FIG. 3C, a message unread icon 335 can appear in place of or alongside the delivery successful icon 330 until the message is read by the recipient or the chat system determines that the likelihood that the message has been read is high. Various types of icons can be used to represent that a message is likely unread, however the invention is not limited in this regard and the GUI 300 can instead notify the sender of the message status by adjusting a color, font, or size in the display area 305 of the message successfully delivered to the recipient's chat client. In some cases, a different color, size, or font for the message can be provided once is it determined that there is a low likelihood that the message was read. Additionally, a combination of altered indicia can also be used.

The GUI 300 can also be configured to provide various indicia to indicate to the sender that the message likely has been read by the recipient. For example, as shown in FIG. 3D, a message likely read icon 340 can appear in place of or alongside the delivery successful icon once the message is read by the recipient or if the chat system determines that the likelihood that the message has been read is high. Various types of icons can be used to represent that a message has likely been read. However, the invention is not limited in this regard and the GUI 300 can instead notify the sender of the message status by adjusting a color, font, or size in the display area 305 of the message delivered to the recipient's chat client. In some cases a different color, size, or font for the message can be provided once a high likelihood that the message was read is determined. Additionally, a combination of altered indicia can also be used.

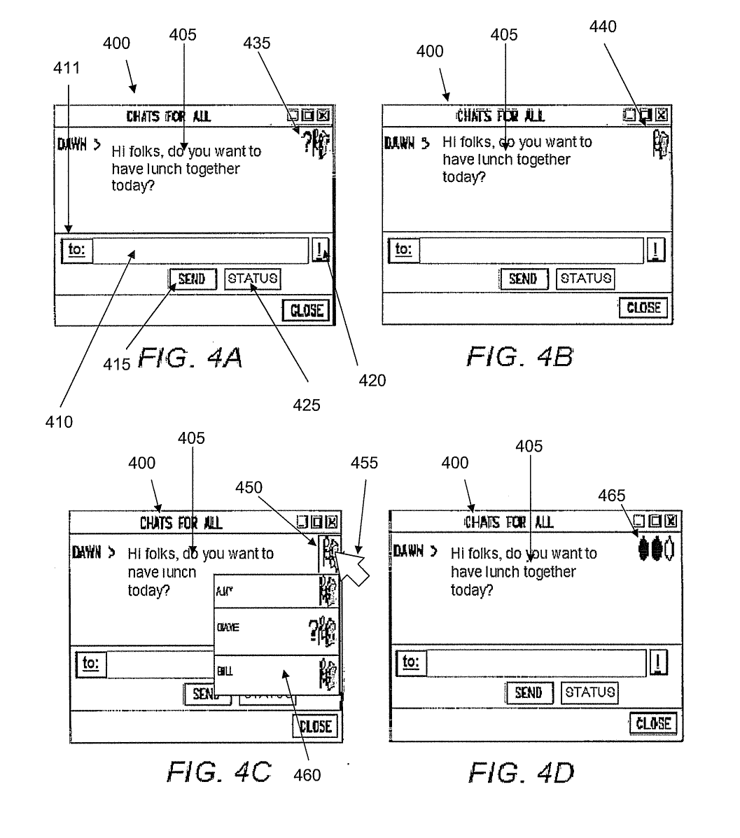

FIGS. 3A-3D illustrate the case where a sender sends a message to a single recipient. However, it is within the scope of the disclosure to be able to send a message to multiple recipients, and a chat client can be provided for such purposes, as shown in FIGS. 4A-4D.

In FIG. 4A, a GUI 400 shows a chat client configured for delivery of messages to multiple recipients. As with GUI 300, GUI 400 can include a display region 405, which shows all messages sent by the various senders during a chat messaging session. Typically, each message is set off by the sender's name or identification (“DAWN”) and followed by the text of the message (“Hi folks, . . . ”). The GUI 400 can also include an input region 410 for entering the message and a send control 415 to instruct the client to deliver the message. The GUI 400 can also include a recipient control 411 for selecting one or more recipients for the message. Various means are available in the art for selecting a list of recipients, including, but not limited to, a separate dialog box, drop-down menus, and other objects. Additionally or alternatively, the chat client can support manual entry of multiple recipients into the input region 410.

As in GUI 300, the GUI 400 a sender can select if he wishes the status of the message to be provided to the chat client after the message is delivered. GUI 400 can provide such functionality with a priority selection control 420. In FIG. 4A, the priority control 420 is shown as a “!” button next to the input region. The present invention is not limited to a button for the selection control 420 and other GUI input objects can be used, including, but not limited to, drop down menus, selection boxes, or codes entered with the message, as previously discussed. Additionally, GUI 400 can have the option of requesting a status message from only a subset of the recipients selected. Various means are available in the art for selecting from a list of recipients, including, but not limited to, a separate dialog box, drop-down menus, and other objects.

GUI 400 is also not limited to only being able to request a status of message only when the message is sent. In some embodiments, a status control 425 can be provided. In such embodiments, a message already sent by the sender can be selected from the display region and the status control 425 can be activated to request the recipient's chat client to provide the status of the message. Various methodologies for selecting a message are well known to those of ordinary skill in the art and are within the scope of the present invention.

The GUI 400 can also be configured to provide various indicia to the sender that the message has been received. For example, a delivery successful icon (not shown) can be displayed alongside a message in the display area 405 once it is determined by the chat system that the recipients' chat clients have successfully received the message. Various types of icons can be used to represent a successful delivery, however the invention is not limited in this regard and the GUI 400 can instead be modified by adjusting a color, font, or size of the message successfully delivered to the recipient's chat client. Also, various combinations of indicia can be used, as previously discussed.

The GUI 400 can also be configured to provide various indicia to the sender that the message has not likely been read by the recipients. For example, as shown in FIG. 4A, a message unread icon 435 can appear in place of or alongside a delivery successful icon until it is determined that the message has been read by the recipients or the chat system determines that the likelihood that the message has been read is high. Various types of icons can be used to represent that a message is unread, however the invention is not limited in this regard and the GUI 400 can instead be modified by adjusting a color, font, or size of the message successfully delivered to the recipient's chat client, as previously discussed.

The GUI 400 can also be configured to provide various indicia to the sender that the message has likely been read by the recipients. For example, as shown in FIG. 4B, a message likely read icon 440 can appear in place or alongside the delivery successful icon or the message unread icon 435 once the message is read by the recipient or the chat system has determined that the likelihood that the message has been read is high. Various types of icons can be used to represent that a message has been read, however the invention is not limited in this regard and the GUI 400 can instead be modified by adjusting a color, font, or size of the message successfully delivered to the recipient's chat client, as previously discussed.

However, in the case of multiple recipients, the icon 440 can be configured to be displayed only if certain conditions apply. For example, the icon 440 may only be display once all recipients have likely read the message. In another example, the icon 440 may only be displayed once a least some minimum number of recipients have read the message. In other embodiments, a color of the icon 440 can be progressively altered based on the number of recipients that have likely read the message. For example, the icon 440 can be a first color when at least one recipient has read the message and can be changed to a second color once all recipients have read the message. Multiple colors can be used to represent other numbers of recipients having likely read the message. Similarly, in the case of adjusting the font, color, or size of the message text, the changes can also be made progressively.

Alternatively, a read review icon 450 can be provided for a sender to view the recipients who have read the message. For example, as shown in FIG. 4C, a sender could select with a GUI control 455 (e.g., a mouse cursor or other GUI control) the icon 450 to bring up a list of recipients 460 and the message status for each. The message status can be provided according to any of the methods previously described. The list 460 can be provided as a drop-down menu, a separate dialog box, or any other method known for a GUI or other interface. However, the present invention is not limited to using only a read review icon 450, and the list 460 can be activated by selecting the message itself or by selecting the message and the status control 435.

In other embodiments, a graphical representation of the number of recipient having likely read the message can be provided, as shown in FIG. 4D. In such embodiments, a read review display 465 can be provided to directly show the number of recipients that have likely read the message. Additionally, the GUI 400 can be configured to allow the sender to select the review display 465 so as to bring up a list of recipients, as previously described. The read review display can include various types of icons that can be used to represent that a message has been read, not read, or delivered. The icons in the display 465 can be selected and displayed according to any of the methods previously described. In some cases, a large number of recipients may be selected and displaying a review display 465 corresponding to the total number of recipient can be hard to display. In such embodiments, the review display can be adjusted proportionally. That is, the same display can be used for any number of recipients, and the display can be adjusted according to the proportion of recipients likely to have read the message. In yet another embodiment, a number can be shown in place of the review display 465 to show with the number of recipients who have likely read the message or who have likely not read the message.

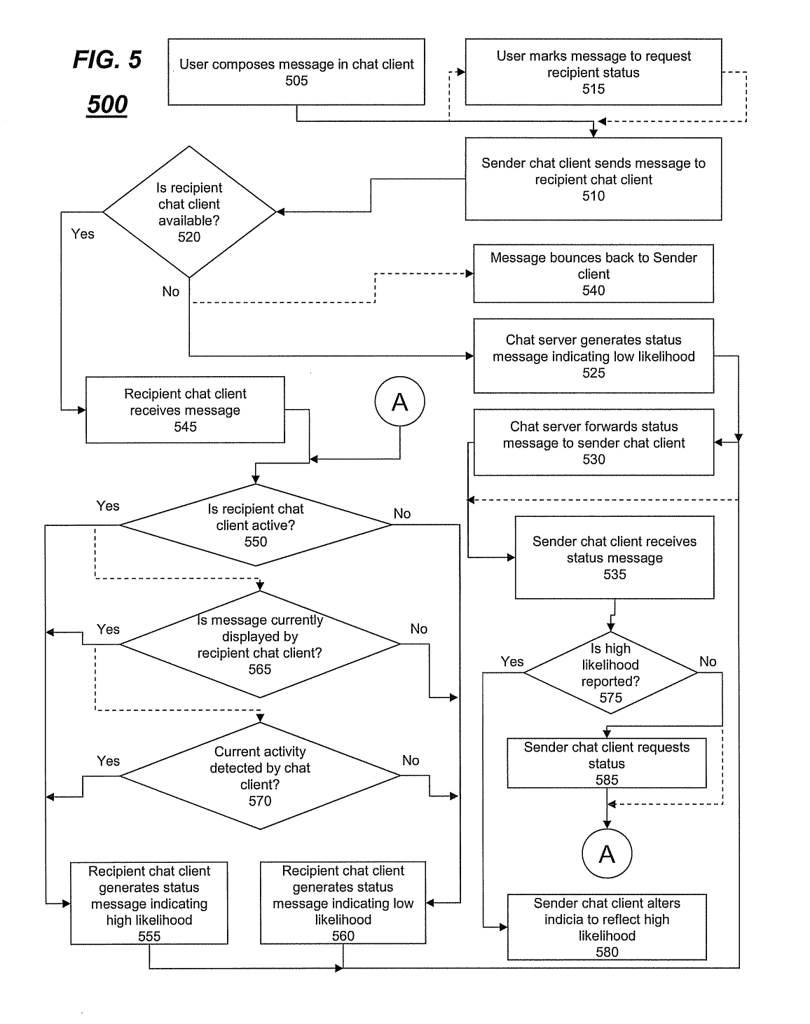

FIG. 5 depicts a flowchart representing an exemplary method 500 for determining and displaying in a sender's chat client indicia representing a likelihood that a message has been read by a recipient. Method 500 begins with a sender composing a message in a chat client in step 505. The sender can then, in step 510, have the chat client send the message to the recipient. As previously noted, the sender is not limited to messaging a single recipient, and, prior to sending the message, the sender can select one or more recipients.

Alternatively or in combination with steps 505 and 510, the sender, in step 515 can select whether he wishes to receive status messages. As previously noted, the sender may select which recipients he wishes to receive status messages from or may select not to receive any status messages at all.

Regardless of whether one or all recipients are selected by the sender in step 510, the method 500 proceeds to step 520 after the message is sent in step 510. In step 520, the message proceeds through the communications network 100, where it can be determined if the recipient chat client is currently unavailable. For example, a chat client can be unavailable if the recipient's terminal is turned off or if the recipient's chat client software is currently not in use. Thus, in a client-server architecture, if the recipient's chat client is not available in step 520, in step 525 the server 110 can generate a status message for the sender's chat client indicating that the message was not delivered and that the message was not read. The chat server 110 can then forward the message to the sender's chat client in step 530, and the sender's chat client can receive the message in step 535. In some embodiments, however, a status message is not generated by a chat server 110, and the message can simply be “bounced” back to the sender's chat client in step 540, which can then be interpreted by the sender's chat client to indicate failure of delivery and that the message was not read.

However, if the recipient's chat client is available in step 520, the message can be forwarded and received by the recipient's chat client in step 545. The recipient's chat client can then review the message and determine if the sender has requested that a status message be generated for the chat message. In embodiments where the sender does not select whether or not a status message should be generated, chat clients can be configured to generate such messages automatically. In either case, the recipient's chat client can at least immediately generate a message that the message has been delivered and forward the status message to the sender's chat client. In the present invention, the recipient's chat client can also immediately determine the status of the message. Accordingly, the message can also include a determination of the likelihood a recipient has read the message. However, the invention is not limited in this regard and a separate status message can also be sent to the sender's chat client, either concurrently or at a later time.

A determination that a recipient has likely read a message can be made in several different ways. A first method, as shown in FIG. 5, is to check whether the recipient chat client is active in step 550. This method is based on the assumption that if a chat client window is currently in use, it is likely that the recipient will see the incoming message from the sender. However, “active” can have several meanings, and detecting current activity in the chat client is not the only means to determine that a client is active. For example, a chat client can be considered “active” if the chat client application window is not currently minimized in a multitasking environment. In another example, the chat client can be considered “active” if the chat client window is the topmost window in a windowed multitasking environment. In yet another example, the chat client can be considered active if the chat client application has not been placed in any type of standby or sleep mode by the recipient. Other “active” states can be defined, and the examples above should not be considered limiting, but merely exemplary.

Accordingly, if the recipient's chat client is determined to be active in step 550, the recipient's chat client can then generate a status message in step 555 for the sender's chat client that a high likelihood the message was read exists. In contrast, if the recipient chat client is determined to be inactive in step 550, the recipient chat client can instead generate a status message in step 560 for the sender's chat client that there is a low likelihood that the message was read, given that the recipient chat client is inactive and not currently in use.

Alternately or in combination with step 550, a second method can be used to determine the likelihood that the recipient has read the message. In step 565, the recipient's chat client can determine whether it is currently displaying at least a portion of the message. This method is based on the assumption that if the message is immediately visible in the recipient's chat client, the likelihood is higher that the recipient has seen at least a portion of the message. Thus, a significant likelihood can exist since a recipient could see the message and read it without having to interact with the chat client. Accordingly, if the recipient chat client is currently displaying at least a portion of the message, the recipient chat client can then generate a status message for the sender's chat client that a high likelihood the message was read exists in step 555. In contrast, if no portion of the message is currently being displayed, the recipient's chat client can then generate a status message for the sender's chat client in step 560 indicating a low likelihood that the message was read. In some embodiments, a high likelihood can instead merely be determined if the entire message is displayed or if only the last portion of the message is displayed in the recipient's chat client. A general comment here—I don't see this written up anywhere but I might have missed reading it—The time duration involves multiplying the number of words by some value (could be user-defined) for time needed to read a word.

Alternately, or in combination with steps 550 and 565, a third method can be used to determine the likelihood that the recipient has read the message. In step 570, the recipient's chat client can determine whether there has been any recent activity in the recipient's chat client window. This method is based on the assumption that if the recipient has recently operated within chat client window, there is still a significant likelihood that the recipient is still at the terminal and can see the message. Thus, a low likelihood that a recipient has read the message can exist if no recent activity in the chat client window has been detected by the recipient's chat client over a fixed period of time. However, recent activity can be measured in several ways. For example, if a minimum amount of time has passed since the recipient last interacted with a chat client window or even with the terminal itself, the recipient's chat client can determine that there is a low likelihood that the recipient has read the message. In another example, if several messages have been received by the recipient's chat client within a minimum period of time without recipient interaction in the chat client window, the recipient's chat client can also determine that there is a low likelihood that the recipient has read the message. Regardless of the method, if the recipient chat client can detect current or recent activity in step 570, the recipient chat client can then generate a status message for the sender's chat client that a high likelihood the message was read exists in step 555. If not, the recipient chat client can then generate a status message for the sender's chat client in step 560 that a low likelihood the message was read exists.

The methods in steps 550, 565, and 570 can be used separately or in any combination. Furthermore, other methods or measures for the likelihood of reading messages are also applicable to the present invention. Furthermore, different weights can be applied to the result of each method, such that one result or a combination of results is more significant for determining the likelihood that a message was read. Regardless of which methods are used, once the status message is generated in step 555 or step 560, the status message can be sent to the chat server 110 and forwarded to the sender's terminal in step 530. The sender's chat client then receives the status message in step 535. In embodiments where a peer-to-peer architecture is used, the status messages can be directly forwarded to the sender's chat client along the peer systems.

Once the sender's chat client receives the status message in step 535, in step 575, the sender's chat client can determine if the status message indicates a high likelihood that message was read. If the status message indicates a high likelihood in step 575, the sender's chat client in step 580 can then change the indicia to indicate the high likelihood. However, if the status message indicates a low likelihood, no changes are made in the sender's chat client GUI. A sender can then request that the status be checked again in step 585 and the recipient's chat client can repeat steps 550 to 570 to determine if the status has subsequently changed. However the invention is not limited to waiting for a query from the sender's chat client and the recipient's chat client can also perform steps 550 to 570 continuously until the likelihood the message has been read is high.

Other modifications to the invention as described above are within the scope of the claimed invention. For example, the present invention is equally applicable to chat clients without graphical elements, such as in a text based chat client. In another example, the present invention is equally applicable to other message systems, including email systems, text messaging system (SMS and MMS), and fax messaging systems. These are but a few examples of modifications that can be applied to the present disclosure without departing from the scope of the claims stated below. Accordingly, the reader is directed to the claims section for a fuller understanding of the breadth and scope of the present disclosure.

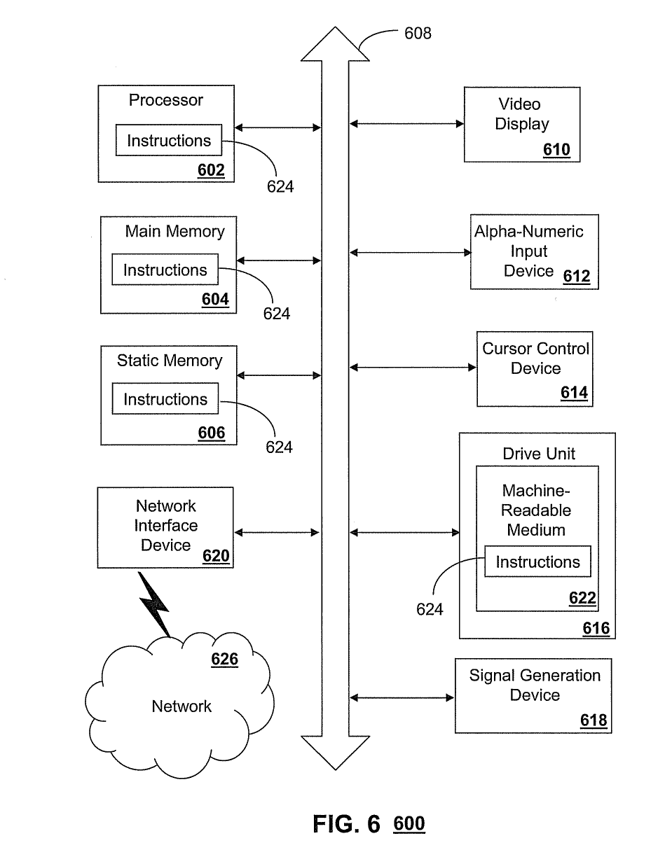

FIG. 6 depicts an exemplary diagrammatic representation of a machine in the form of a computer system 600 within which a set of instructions, when executed, can cause the machine to perform any one or more of the methodologies discussed above. In some embodiments, the machine operates as a standalone device. In some embodiments, the machine can be connected (e.g., using a network) to other machines. In a networked deployment, the machine can operate in the capacity of a server or a client user machine in a server-client user network environment, or as a peer machine in a peer-to-peer (or distributed) network environment.

The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a processor 602 (e.g., a central processing unit (CPU), a graphics processing unit (GPU), or both), a main memory 604 and a static memory 606, which communicate with each other via a bus 608. The computer system 600 can further include a video display unit 610 (e.g., a liquid crystal display (LCD), a flat panel, a solid state display, or a cathode ray tube (CRT)). The computer system 600 can include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 can include a machine-readable medium 622 on which is stored one or more sets of instructions (e.g., software 624) embodying any one or more of the methodologies or functions described herein, including those methods illustrated above. The instructions 624 can also reside, completely or at least partially, within the main memory 604, the static memory 606, and/or within the processor 602 during execution thereof by the computer system 600. The main memory 604 and the processor 602 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of the various embodiments include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 can further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments can be utilized and derived therefrom, such that structural and logical substitutions and changes can be made without departing from the scope of this disclosure. Figures are also merely representational and can not be drawn to scale. Certain proportions thereof may be exaggerated, while others may be minimized. Accordingly, the specification and drawings are to be regarded in an illustrative rather than a restrictive sense.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method for indicating in a messaging client the status of a message, the method comprising the steps of:
composing said message in a messaging client associated with a sender;
sending said message to at least one recipient;
receiving a status message for a messaging client associated with said at least one recipient, wherein said status message indicates a likelihood that said at least one recipient has read said sent message; and
in response to receiving said status message, providing an indicia in said sender messaging client to indicate said likelihood that said sent message has been read by said at least one recipient.

2. The method of claim 1, further comprising:
prior to said receiving step, generating said status message in said messaging client associated with said at least one recipient; and
sending said status message to said sender messaging client.

3. The method of claim 2, said generating step further comprising:
ascertaining whether at least a portion of said sent message is currently displayed in said messaging client associated with said at least one recipient; and
if a portion of said message is currently displayed, generating a status message, wherein said status message indicates a high likelihood that said message has been read by said at least one recipient.

4. The method of claim 2, said generating step further comprising:
if said messaging client associated with said at least one recipient is inactive, generating a status message indicating a low likelihood that said sent message has been read by said at least one recipient.

5. The method of claim 2, said generating step further comprising:
if said messaging client associated with said at least one recipient is active and at least a minimum amount of time has passed since said at least one recipient has interacted with said messaging client associated with said at least one recipient, generating a status message indicating a low likelihood that said sent message has been read by said at least one recipient.

6. The method of claim 1, wherein if said sent message is sent to at least two or more recipients, providing separate indicia for each of said recipients.

7. The method of claim 1, further comprising:
requesting in said sender messaging client a status of said sent message.

8. A system for supporting messaging between a plurality of users, said system comprising a messaging server for sending to at least one recipient a message composed in a messaging client associated with a sender and for forwarding a status message from a messaging client associated with said at least one recipient to said sender messaging client, wherein said status message indicates a likelihood that said at least one recipient has read said sent message, and wherein said sender messaging client alters an indicia in said sender messaging client to indicate said likelihood that said message has been read by said at least one recipient in response to receiving said status message.

9. The system of claim 8, wherein said status message is generated in said messaging client associated with said at least one recipient.

10. The system of claim 9, wherein said status message indicates a high likelihood that said sent message has been read by said at least one recipient if a portion of said message is currently displayed in said messaging client associated with said at least one recipient.

11. The method of claim 9, wherein said status message indicates a low likelihood that said sent message has been read by said at least one recipient if said messaging client associated with said at least one recipient is inactive.

12. The method of claim 9, wherein said status message indicates a low likelihood that said message has been read by said at least one recipient if said messaging client associated with said at least one recipient is active and at least a minimum amount of time has passed since said messaging client associated with said at least one recipient has detected activity.

13. The method of claim 8, wherein said messaging server is further configured to forward a request for a status of said sent message to said messaging client associated with said at least one recipient.

14. A computer-readable storage medium, having stored thereon a computer program having a plurality of code sections comprising computer instructions executable by a machine for causing the machine to perform the steps of:
sending a message composed in a sender messaging client to at least one recipient messaging client;
receiving a status message from said at least one recipient messaging client, wherein said status message indicates a likelihood that a recipient associated with said at least one recipient messaging client has read said sent message; and
altering an indicia in said sender messaging client in response to receiving said status message to indicate said likelihood that said sent message has been read by a recipient associated with said at least one recipient messaging client.

15. The storage medium of claim 14, further comprising computer instructions for:
prior to said receiving step, generating said status message in said at least one recipient messaging client; and
sending said status message to said sender messaging client.

16. The storage medium of claim 15, said generating step further comprising:
ascertaining whether at least a portion of said sent message is currently displayed in said at least one recipient messaging client; and
if a portion of said sent message is currently displayed, generating a status message indicating a high likelihood that said message has been read by said at least one recipient.

17. The storage medium of claim 15, said generating step further comprising:
if said at least one recipient messaging client is inactive, generating a status message indicating a low likelihood that said sent message has been read by said at least one recipient.

18. The storage medium of claim 15, said generating step further comprising:
if at least a minimum amount of time has passed since activity was detected in said at least one recipient messaging client, generating a status message indicating a low likelihood that said sent message has been read by said at least one recipient.

19. The storage medium of claim 14, wherein if said sent message is sent to at least two or more recipient messaging client, providing separate indicia for each of said recipient messaging clients.

20. The storage medium of claim 14, further comprising computer instructions for:
requesting in said sender messaging client a status of said sent message.
